(19) United States
(12) Patent Application Publication
(10) Pub. No.: US 2006/0048015 A1
(43) Pub. Date: Mar. 2, 2006

(54) System integration test rig for networked overall mechatronic systems

(75) Inventors: Thomas Bardelang, Leinfelden-Echterdingen (DE); Hans-Juergen Gutmayer, Waiblingen (DE); Gerhard Pfeiffer, Deizisau (DE); Marco Rooney, Neuhausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/211,504

(22) Filed: Aug. 26, 2005

(30) Foreign Application Priority Data
Aug. 27, 2004 (DE) 102004041428.9

(51) Int. Cl. G06F 11/00

(52) U.S. Cl. 714/45

(57) ABSTRACT

A system integration test rig for networked overall mechatronic systems includes mechanical and/or electronic components in the form of a mathematical model or real assemblies. According to the invention, the mechanical and/or electronic components are provided in the form of modules, each having its own power supply. The modules can be operated in a spatially distributed form, and communicate with one another via a communication link with a real-time capability, preferably via an Ethernet link. The modules can also operate autonomously.

### BACKGROUND AND SUMMARY OF THE INVENTION

This application claims the priority of German patent document 102004041428.9, filed Aug. 27, 2004, the disclosure of which is expressly incorporated by reference herein.

The invention relates to a system integration test rig for networked overall mechatronic systems.

A large number of test and system integration steps are performed during the development of overall networked mechatronic systems, such as vehicles, aircraft etc. In order to satisfy adequately the requirements for test tasks, individual test rigs are generally developed for each integration step, which can result in a very large number of insular solutions that are very expensive, inflexible and incompatible with one another.

System integration test rigs are known which carry out a simulation form that is also referred to as HiL (hardware-in-the-loop) simulation. Such system integration test rigs generally cover the entire electronics architecture of an overall mechatronic system. The electronic and/or mechanical components can be simulated as a mathematical model with a real-time capability, or can be installed as real assemblies. The model is connected to the controller inputs and outputs via a computer peripheral with a real-time capability, including I/O processing. The overall system can then be operated as in the real overall mechatronic system.

German patent document DE 42 12 890 C2 describes an arrangement for testing the output response of controllers for driving inductive or capacitive loads. The controller is tested in the operating mode that corresponds to the normally connected operating load.

German patent document DE 43 30 312 C2 discloses a method and apparatus for checking arrangements of networked controllers in the development phase of motor vehicles. The test arrangement of controllers is formed and the behavior of the controllers in the test arrangement is then investigated, with the test arrangement corresponding to the subsequent arrangement to the extent that the electrical connections of the controllers are equivalent to the controller connections provided in the vehicle. The control variables, which are recorded by sensors in the vehicle and are transmitted to controller input interfaces, are calculated by a real-time computer in the test arrangement, and are transmitted to the input interfaces. The actuating signals produced in the controllers and emitted via the output interface are transmitted to the real-time computer for this purpose, which determines the control variables on the basis of the actuating signals and a vehicle model. In this case, the controllers must also be supplied with control variables that can be adjusted as required by the driver in the vehicle.

German patent document DE 100 01 484 C1 discloses an apparatus for simulation of electrical components, which has a drive module that provides a model of the components to be simulated and produces the interface signals in a corresponding manner to the signals of the real components to be simulated.

One object of the invention is to provide a system integration test rig for networked overall mechatronic systems, which is flexible and can be optimally matched to test tasks that arise.

This and other objects and advantages are achieved by the system integration test rig according to the invention, in which the mechanical and/or electronic components of a system integration test rig for networked overall mechatronic systems are in the form of modules, each having its own power supply. The modules can be operated in a spatially distributed form and communicate with one another via a communication link with a real-time capability (preferably via an Ethernet link).

The modular structure of the system integration test rig makes it possible to map the entire electronics architecture of an overall mechatronic system, such as a vehicle, an aircraft or the like, for which the modules can advantageously be spatially distributed. The modular configuration and the coupling of the modules via the communication link with a real-time capability, such as the Ethernet or the like, means that the system integration test rig is highly flexible and can be quickly matched to different test tasks.

In one embodiment of the invention, the modules can be distributed over a plurality of development sites, and communicate with one another via the Internet using protocols with a real-time capability. In this manner, a test equipment landscape can be established within an organization, which has a homogeneous structure, with the additional capability to reproduce and unambiguously interpret test results at the different sites. Furthermore, this results in major cost savings, because the development costs for the system integration test rig are incurred only once, and because incompatible system integration test rigs for networked overall mechatronic systems at different sites are avoided.

In a further refinement of the system integration test rig according to the invention, at least one module can be removed from the system integration test rig, and operated independently as an individual test rig and/or as a test rig element.

This allows the individual modules to be used advantageously as an individual test rig for a single mechatronic subsystem (for example an engine controller, transmission controller, gas-turbine controller or the like). If two or more modules are removed from the overall test rig, more complex subsystems, such as a drive train which includes the engine controller and the transmission controller, can be tested and checked. Furthermore, the rest of the system integration test rig can still be used to check other subsystems. In an extreme example, the system integration test rig comprises, by way of example, ten modules arranged at ten sites, which can be used for checking ten subsystems. In addition, the ten modules can be combined with one another as required, in order to test more complex subsystems via the communication link with a real-time capability.

In a further refinement of the system integration test rig, at least one control computer is provided, and controls, for example, the system integration test rig and/or the individual test rig and/or the test rig element.

The modules of the system integration test rig may be in the form of, for example, an engine module, a transmission module, and/or an instrument module and/or a window module.

In a further refinement of the system integration test rig, a standardized rack is provided for holding the individual modules.

A module according to the invention for a system integration test rig has an electronics area with an actuator and/or sensor functionality, for production of appropriate actuator signals and/or sensor signals, as well as an interface area with a real-time computer system for simulation control, a signal preprocessing area, and a standard power supply unit for supplying power to the module.

In another embodiment of the invention, the module has an interface via which controller signal lines are passed directly. The interface is advantageously in the form of an insert which holds the modules. The modules are signal distributors, blade isolating terminal blocks or electronic apparatuses for automatic introduction of short circuits and/or signal interruptions on the controller signal lines.

In a further refinement of the invention, the module has at least one standard coupling module with connections for connection of servicing appliances and/or diagnosis appliances and/or controllers.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a system integration test rig according to the invention;

FIG. 2 is a block diagram of a first embodiment of a distributed system integration test rig;

FIG. 3 is a block diagram of a second embodiment of a distributed system integration test rig; and

FIG. 4 is a block diagram of a module for the system integration test rig shown in FIGS. 1 to 3.

### DETAILED DESCRIPTION OF THE DRAWINGS

As can be seen from FIG. 1, a system integration test rig according to the invention 100 for a networked overall mechatronic system, such as a vehicle, an aircraft or the like, has mechanical and/or electronic components 10 to 50, which are in the form of modules with their own power supply 6. The modules 10 to 50 comprise mathematical models and/or real components such as actuators and sensors. The modules 10 to 50 (or the model in the modules 10 to 50) is connected to controller inputs and outputs via a computer peripheral with a real-time capability and including input/output data processing. The corresponding module 10 to 50 can now be operated in the same way as in the real overall mechatronic system. In addition, a control computer 60 is provided for controlling the system integration test rig 100.

By way of example, the modules 10 to 50 may be in the form of an engine module 10, transmission module 20, instrument module 30, and/or window module 50. The three dots are intended to indicate that the system integration test rig 100 may also include more modules, for example modules for systems for axle kinematics that can be influenced actively, controlled suspension and shock absorbing systems, braking systems, air-conditioning controllers, navigation appliances, etc.

A novel feature of the modular system integration test rig 100 in comparison to conventional systems is the modularity of individual test rig components 10 to 50. This means that an individual module 10 to 50 represents a mechatronic subsystem or controller, can be removed from the overall system on the test rig 100, and can be operated independently. The “rest” of the test rig 100 remains operable during this process. Further modules can likewise be removed, and can be operated at a physical distance as an overall system 100, by means of a communication link 80 with a real-time capability.

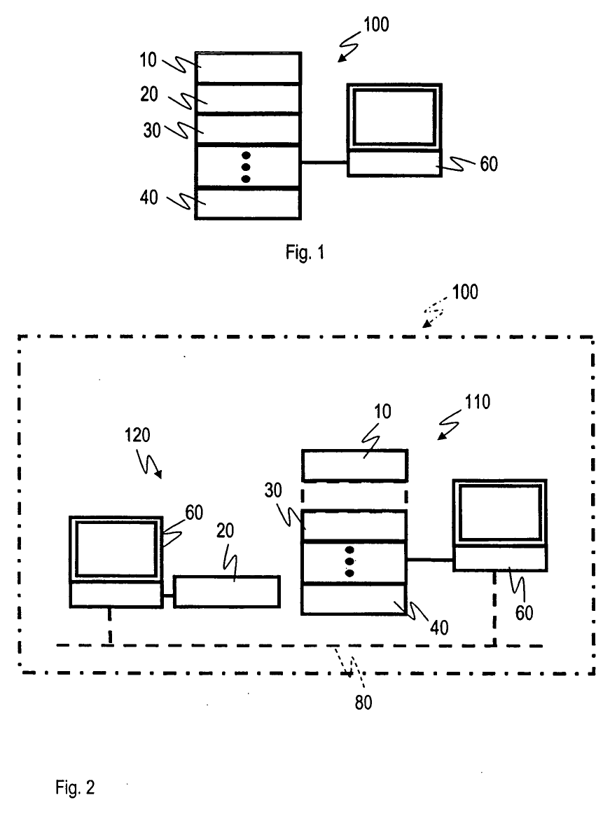

FIG. 2 shows the system integration test rig 100 from which the transmission module 20 has been removed and is connected to its own control computer 60. This can be done for any desired one of the modules 10 to 50. The rest of the system 110 and the newly created subsystem 120 can also be operated as an overall system 100, illustrated by dashed-dotted lines, via the communication link 80, which is illustrated by dashed lines and has a real-time capability. For example, the subsystem 120 allows transmission tests to be carried out independently, and engine tests etc can be carried out with the rest of the system 110.

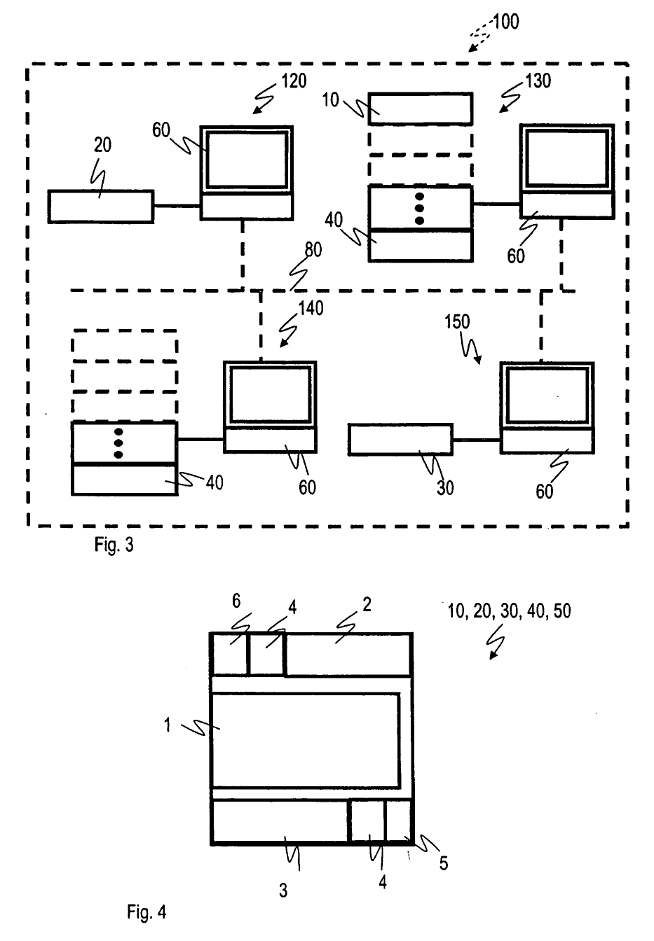

FIG. 3 shows a system integration test rig 100 distributed between four subsystems 120, 130, 140 and 150, which can be operated as an overall system 100 via the real time communication link 80, as illustrated by dashed-dotted lines. The subsystems 120 and 150 are in the form of individual test rigs (that is, they each have only one module that has been removed from the overall system). The subsystems 130 and 140 are in the form of test rig elements (that is, they each have two or more modules.

The modules 10 to 50 in FIG. 3 are distributed between various development sites, for example with the subsystem 120 being located in Stuttgart, the subsystem 130 in Sindelfingen, the subsystem 140 in Detroit, and the subsystem 150 in Berlin. Despite the great physical distance, the modules 10 to 50 can be joined together again and can be operated as an overall system 100, provided that the communication link 80 has a real-time capability. The individual modules 10 to 50, the overall test rig 100 or test rig elements 110 to 150 can also be operated independently of one another. This is ensured by the overall mechatronic model having an intelligent model structure. In this case, individual model modules and remaining bus simulations can be added or removed.

The individual modules 10 to 50 may, for example, be plugged together in a standardized rack.

The configuration of the individual modules 10 to 50 will be described in the following text with reference to FIG. 4, with the configuration of the individual modules 10 to 50 being standardized.

As can be seen from FIG. 4, a module 10 to 50 for a system integration test rig 100 has an electronics area 1 with an actuator and/or sensor functionality for production of appropriate actuator signals and/or sensor signals, an interface area 2 with a real-time computer system for simulation control and a signal preprocessing area, a standard power supply unit 6 for supplying power to the module 10 to 50, a distributor area 3 having blade isolating terminals via which signals can be passed and which automatically produces short-circuits and/or interruptions, at least one standard coupling module 4 with connections for connection of servicing appliances and/or diagnosis appliances and/or controllers, and a vehicle module 5 with connections such as terminals Kl15, Kl30, Kl31.

Each of the individual modules 10 to 50 intrinsically represents a small test rig. The electronics area 1 simulates the actuators and sensors, or models the actuators and sensors, depending on the configuration of the module 10 to 50.

The interface area 2 has electronics inserts which, for example, include the real-time computer which calculates the simulation control and the model, input/output plug-in boards and/or CAN plug-in boards, which are used for signal preprocessing.

The distributor area 3, which is also referred to as a patch module area, comprises blade isolating terminals via which the signals are passed. These patch field blocks may be in the form of inserts. If required, the patch field blocks may be replaced by short-circuiting and/or interruption modules, which can produce short-circuits and interruptions automatically.

The at least one standard coupling module 4 is used for development, servicing and diagnosis purposes for the module 10 to 50 itself. The internal connections and signals of the input/output boards and of the real-time computer are passed out there. In the illustrated exemplary embodiment, a standard coupling module 4 such as this is available both on the front face and on the rear face of the module 10 to 50. Furthermore, the connections for the control computer are provided there.

Connections such as Kl15, Kl30, Kl31 and CAN are passed out on the vehicle module 5 and are used essentially for connection of external test equipment for single operation of the module 10 to 50.

Each module 10 to 50 is supplied with electrical power via the standard power supply unit 6.

The dimensions of the individual modules 10 to 50 can be designed such that the width of the test rig 100 can preferably be 19 inches. Depending on the space requirement, the height of the modules 10 to 50 may be between 3 and 9 height units.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system integration test rig for a networked mechatronic system, the test rig having mechanical and/or electronic components in the form of a mathematical model and/or real assemblies; wherein:
the components are in the form of modules;
each module has its power supply; and
the components are operable in a spatially distributed form and communicate with one another in real time via a communication link.

2. The system according to claim 1, wherein said network comprises one of the Internet, an organization network and an Ethernet.

3. The system integration test rig as claimed in claim 2, wherein the modules are distributed over a plurality of development sites and communicate with one another via the Internet using protocols, with a real-time capability.

4. The system integration test rig as claimed in claim 3, wherein at least one module removable from the system integration test rig and can be operated independently as an individual test rig or as a test rig element.

5. The system integration test rig as claimed in claim 4, including a control computer for controlling at least one of the system integration test rig, the individual test rig, and the test rig element.

6. The system integration test rig as claimed in claim 5, wherein each module is in the form of one of an engine module, a transmission module, an instrument module, and a window module.

7. The system integration test rig as claimed in claim 6, further comprising a standardized rack for holding the individual modules.

8. A module for a networked mechatronic system, the test rig having mechanical and/or electronic components in the form of a mathematical model and/or real assemblies, said module comprising:
an electronics area with at least one of an actuator and sensor functionality, for production of appropriate actuator or sensor signals;
an interface area with a real-time computer system for simulation control and with a signal preprocessing area; and
a standard power supply unit for supplying power to the module.

9. The module as claimed in claim 8, further comprising a distributor area to which controller signal lines are connected directly and in which blade isolating terminals, signal distributors or apparatus for automatic introduction of signal interruptions or short-circuits are accommodated or connectable.

10. The module as claimed in claim 9, further comprising at least one standard coupling module with connections for connection of at least one of servicing appliances, diagnosis appliances and controllers.
